(19) United States
(12) Patent Application Publication
(10) Pub. No.: US 2019/0210571 A1
(43) Pub. Date: Jul. 11, 2019

(54) SYSTEM AND METHOD FOR CONTROL OF REAR WIPER

(71) Applicant: Ford Global Technologies, LLC, Dearborn, MI (US)

(72) Inventors: Mahmoud Yousef Ghannam, Canton, MI (US); Clara Bennie, Sterling Heights, MI (US)

(21) Appl. No.: 15/864,291

(22) Filed: Jan. 8, 2018

(51) Int. Cl. B60S 1/58; B60S 1/08

(52) U.S. Cl. CPC B60S 1/583; B60S 1/0896; B60S 1/0862

(57) ABSTRACT

A system for a motor vehicle according to an exemplary aspect of the present disclosure includes, among other things, a controller and a rear wiper configured to wipe a rear window of the motor vehicle in response to instructions from the controller. Further, the controller is configured to instruct the rear wiper to run at a predefined speed for a predefined time period based on a plurality of factors. A method is also disclosed.

### TECHNICAL FIELD

This disclosure relates to a system and method for control of a rear wiper.

### BACKGROUND

Motor vehicles are known to have a windshield wiper configured to remove rain, snow, ice, and other debris from the windshield of the vehicle. Many motor vehicles are also fitted with a rear wiper, which is configured to wipe the rear window of the vehicle. Such vehicles include hatchbacks, station wagons, trucks, minivans, and sport utility vehicles (SUVs), as examples. Front and rear wipers are typically controlled separately based on independent, manual user inputs.

### SUMMARY

A system for a motor vehicle according to an exemplary aspect of the present disclosure includes, among other things, a controller and a rear wiper configured to wipe a rear window of the motor vehicle in response to instructions from the controller. Further, the controller is configured to instruct the rear wiper to run at a predefined speed for a predefined time period based on a plurality of factors.

In a further non-limiting embodiment of the foregoing system, a weight is assigned to each of the plurality of factors, and the controller is configured to instruct the rear wiper to run at the predefined speed for the predefined time period based on a weighted sum of the factors.

In a further non-limiting embodiment of any of the foregoing systems, the weights are factory settings of the motor vehicle.

In a further non-limiting embodiment of any of the foregoing systems, the controller is configured to change the weights over time.

In a further non-limiting embodiment of any of the foregoing systems, the controller is configured to instruct the rear wiper to run at a first speed for a first time period when the weighted sum is greater than or equal to an upper threshold.

In a further non-limiting embodiment of any of the foregoing systems, the controller is configured to instruct the rear wiper to run at a second speed for a second time period when the weighted sum is less than the upper threshold and greater than or equal to an intermediate threshold, and the second speed is less than the first speed.

In a further non-limiting embodiment of any of the foregoing systems, the controller is configured to instruct the rear wiper to run at a third speed for a third time period when the weighted sum is less than the intermediate threshold and greater than or equal to a lower threshold, and the third speed is less than the second speed.

In a further non-limiting embodiment of any of the foregoing systems, the controller is configured to stop the rear wiper when the weighted sum is less than the lower threshold.

In a further non-limiting embodiment of any of the foregoing systems, the plurality of factors includes at least two of a user input, a signal from a rain sensor, a speed of the motor vehicle, a signal from a front camera, a gear position, a signal from a rear camera, a vehicle-to-vehicle message, and a shape of an exterior of a body of the motor vehicle.

In a further non-limiting embodiment of any of the foregoing systems, the user input includes a signal indicative of an eye position of the user.

In a further non-limiting embodiment of any of the foregoing systems, the controller is configured to instruct the rear wiper to run at a speed other than the predefined speed based on a user override.

In a further non-limiting embodiment of any of the foregoing systems, the motor vehicle does not include a rear window rain sensor.

A method according to an exemplary aspect of the present disclosure includes, among other things, wiping a rear window by running a rear wiper at a predefined speed for a predefined time period based on a plurality of factors.

In a further non-limiting embodiment of the foregoing method, the method includes assigning weights to the plurality of factors, and running the rear wiper based on a weighted sum of the plurality of factors.

In a further non-limiting embodiment of any of the foregoing methods, the method includes changing the weights over time.

In a further non-limiting embodiment of any of the foregoing methods, the method includes running the rear wiper at a first speed when a weighted sum of the plurality of factors is greater than or equal to an upper threshold, and running the rear wiper at a second speed when the weighted sum is less than the upper threshold and greater than or equal to a first intermediate threshold, the second speed less than the first speed.

In a further non-limiting embodiment of any of the foregoing methods, the method includes running the rear wiper to at a third speed when the weighted sum is less than the first intermediate threshold and greater than or equal to a lower threshold, the third speed less than the second speed.

In a further non-limiting embodiment of any of the foregoing methods, the method includes stopping the rear wiper when the weighted sum is less than the lower threshold.

In a further non-limiting embodiment of any of the foregoing methods, the plurality of factors does not include a signal from a rear window rain sensor.

In a further non-limiting embodiment of any of the foregoing methods, the method includes wiping the rear window by running a rear wiper at a speed other than the predefined speed based on a user override.

### BRIEF DESCRIPTION OF THE DRAWINGS

FIG. 1 is a top view of a motor vehicle including a rear wiper.

FIG. 2 is a flow chart representative of an example method according to this disclosure.

### DETAILED DESCRIPTION

This disclosure relates to a system and method for controlling a rear wiper of a motor vehicle. The disclosed system includes a controller and a rear wiper configured to wipe a rear window of the motor vehicle in response to instructions from the controller. The controller is configured to instruct the rear wiper to run at a predefined speed for a predefined time period based on a plurality of factors. Among other benefits, the disclosed system does not require the user (i.e., the driver) to manually control the rear wiper, which improves customer satisfaction by providing automatic rear wiper control. Further, the disclosed system does not require a dedicated rear window rain sensor, which reduces cost.

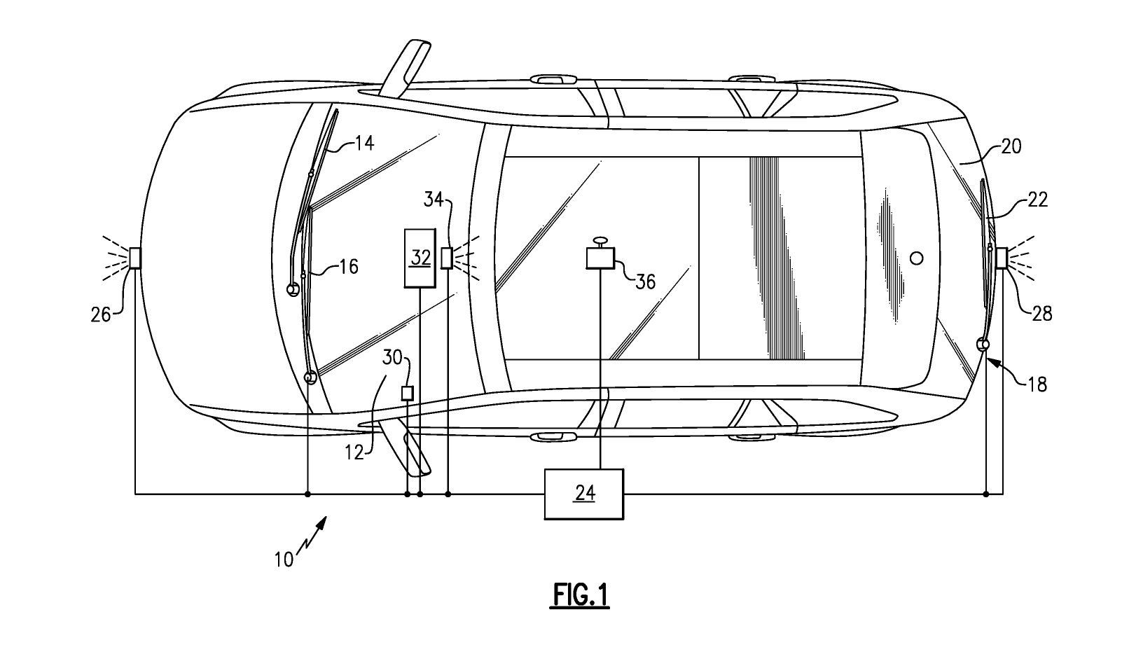

Referring to the drawings, FIG. 1 is a top view of a motor vehicle 10, which is shown as a sport utility vehicle (SUV). While FIG. 1 shows an SUV, this disclosure is not limited to SUVs and extends to other vehicles, including hatchbacks, station wagons, trucks, and minivans, among others. The vehicle 10 includes a windshield 12 (sometimes referred to as a windscreen) and first and second front wipers 14, 16 configured to traverse the windshield 12 to wipe the windshield 12, thereby removing rain, snow, ice, and other debris from the windshield 12. While two front wipers 14, 16 are illustrated in FIG. 1, it should be understood that this disclosure extends to vehicles with one or more front wipers.

In this example, the vehicle 10 includes a liftgate 18 having a rear window 20, which in this example is a flipglass window. The vehicle 10 further includes a rear wiper 22 configured to traverse the rear window 20 to clear water, ice, snow, and other debris therefrom.

The front and rear wipers 14, 16, 22 are operable in response to instructions from a controller 24. The controller 24 is shown schematically in FIG. 1. It should be understood that the controller 24 could be part of an overall vehicle control module, such as a vehicle system controller (VSC), or could alternatively be a stand-alone controller separate from the VSC. Further, the controller 24 may be programmed with executable instructions for interfacing with and operating the various components of the vehicle 10. The controller 24 additionally includes a processing unit and non-transitory memory for executing the various control strategies and modes of the vehicle system.

In this disclosure, the controller 24 is configured to instruct the rear wiper 22 to run at a predefined speed for a predefined time period based on a plurality of factors. As one would understand, reference to the “rear wiper” includes any associated mechanisms, such as actuators, capable of moving the rear wiper. Thus, when the controller 24 provides instructions to the rear wiper 22, the controller 24 provides instructions to, and commands, the mechanisms configured to move the rear wiper 22.

In this disclosure, the term “predefined” refers to a speed or time period that has been determined previously, such as by a factory setting. While a speed may be “predefined,” for example, there may be several predefined speeds (e.g., low, medium, high) at which the controller 24 is configured to instruct the rear wiper 22 to run. The controller 24 may store several predefined speeds and time periods in a lookup table, for example. Based on a plurality of factors, the controller 24 is configured to select the appropriate pair of predefined speeds and time periods from the lookup table. The stored, predefined speeds and time periods may correspond to one another, as generally discussed below. As used in this disclosure, “speed” of the front and rear wipers 14, 16, 22 refers to the rate of movement of the front and rear wipers 14, 16, 22 relative to the windshield 12 and rear window 20, respectively. The term “time period,” as used in this disclosure, refers to a finite amount of time, such as 1 minute.

The controller 24 is configured to receive signals from various sensors and other sources. In this example, the controller 24 is electrically coupled to at least one vehicle camera. In particular, the controller 24 is electrically coupled to a front view camera 26 mounted adjacent a front of the vehicle 10 and a rear backup camera 28 mounted adjacent a rear of the vehicle 10.

The controller 24 is also electrically coupled to a front wiper rain sensor 30. The front wiper rain sensor 30 is mounted adjacent the windshield 12 and is activated when the windshield 12 becomes wet. The front wiper rain sensor 30 is configured to generate a signal indicative of a level of wetness of the windshield 12. The front wiper rain sensor 30 may be any known type of rain sensor, including an infrared sensor, as one example.

The controller 24 also receives information from the user. Such information may include information the user manually inputs via a vehicle infotainment interface 32, such as the SYNC® system, which is commercially available in vehicles manufactured by Ford Motor Company. The vehicle infotainment interface 32 may include a touch screen and/or physical buttons relating to the control of the front or rear wipers 14, 16, 22. Alternatively, the user could manually input information by speaking. The vehicle infotainment interface 32 and controller 24 may be configured to interpret that speech as a particular command. Alternatively or in addition, the user may input information via another type of physical button, such as a button on a turn signal switch or on a steering wheel.

While this disclosure contemplates active, manual user inputs (such as buttons, speech, etc.), the user input could also be a passive input. In this example, one type of passive input is detected by a sensor 34. The sensor 34 may be a camera, in one example. Together with the controller 24, the sensor 34 is configured to monitor the face of the driver of the vehicle 10. More particularly, the sensor 34 is configured to monitor the movement of the eyes of the driver, and the controller 24 is configured to interpret the information from the sensor to determine when the driver is looking at a rear-view mirror mounted in the interior of the vehicle 10. To this end, the sensor 34 may be mounted adjacent or directly to a rear-view mirror of the vehicle 10.

The vehicle 10 may also include a transceiver 36 configured to send and receive messages from other vehicles on the road. To this end, the vehicle 10 may be configured for vehicle-to-vehicle (sometimes abbreviated as “V2V” or “VtV”) communication. In this disclosure, the vehicle 10 may receive information from other vehicles on the road concerning the road conditions or the conditions corresponding to the windshield 12 or rear window 20. The transceiver 36 may also be configured to send and receive information to and from a server or cloud computing network, thereby providing the vehicle 10 with access to certain types of data. Such data may include weather reports, traffic information, etc. The data may also indicate a level of rear wiper usage by drivers of vehicles in the same geographic region at a particular time.

The controller 24 is configured to interpret the signals it receives as factors, and to run the rear wiper 22 based on a plurality of those factors. In one example, the controller 24 considers at least two factors. In another example, the controller considers additional factors. While cameras, sensors, and transceivers 26, 28, 30, 32, 34 are shown, this disclosure is not limited to the particulars of the arrangement of FIG. 1. This disclosure extends to vehicles that do not include all types of cameras, sensors, and transceivers 26, 28, 30, 32, 34, and also extends to vehicles that include additional sensors. As will be discussed below, the controller 24 is configured to weigh the various inputs it receives and to run the rear wiper 22 accordingly.

In one example of this disclosure, the controller 24 assigns weights to a plurality of factors, and instructs the rear wiper 22 to run at a predefined speed and for a predefined time based on a weighted sum of the factors. This can be expressed with reference to the following example equation and table.

Y=W₀X₀+W₁X₁+W₂X₂+W₃X₃+W₄X₄+W₅X₅+W₆X₆+W₇X₇+W_{N}X_{N} (Equation 1)

In Equation 1, Y is a rain-or-clean sensing coefficient, which is determined based on a weighted sum of a plurality of factors, which are represented as X₀ through X_{N}. In this example, X₀ is an active or passive human input, such as that input into the vehicle infotainment interface 32 or detected by the sensor 34. X₁ is the information from the front wiper rain sensor 30, X₂ is a vehicle speed, X₃ is based on information from the front view camera 26, X₄ is a vehicle gear position, X₅ is based on information from the rear backup camera 28, X₆ is based on information from the transceiver 36, and X₇ is based on an exterior shape of the body of the vehicle 10 (i.e., vehicle type, such as SUV, hatchback, minivan, etc.). X_{N} is representative of additional factors that the controller 24 may consider.

The various factors X₀ through X_{N} may relate to the need for wiping the rear window 20. For example, for factor X₀, an example active input includes when a user manually turns on the rear wiper 22, which indicates the desire of the driver for wiping the rear window. For factor X₀, an example passive input includes detecting whether a user is looking into a rear-view mirror of the vehicle 10 using the sensor 34. If the user is looking into the rear-view mirror, the user typically desires the rear window 20 to be clear. For factor X₁, which relates to information from the front wiper rain sensor 30, if the front wiper rain sensor 30 indicates that it is raining, then the rear window 20 is also being covered with rain. Regarding X₂, vehicle speed, more wiping may be needed when the vehicle 10 travels at high speeds. Likewise, regarding X₄, which is vehicle gear position, more wiping may be needed when the vehicle 10 is traveling in reverse. Regarding X₃ and X₅, information from the front and rear cameras may be used to detect whether rain or muddy conditions are present, for example. Regarding X₆, vehicle-to-vehicle communication, the vehicle 10 may make use of information from other vehicles when determining whether to wipe the rear window 20, as will be discussed below. Regarding X₇, rain may accumulate on the rear window in proportion to the rain of the windshield 12. That portion may be directly related to the shape of the exterior of the body of the vehicle 10. Finally, regarding X_{N}, additional variables might be useful in light of unique vehicle configurations or regional environmental conditions.

In Equation 1, W₀ through W_{N} are weights assigned to each of the factors X₀ through X_{N}. The weights W₀ through W_{N} may be factory settings. That is, the weights W₀ through W_{N} are assigned in a factory setting by the vehicle manufacturer. In one example, the controller 24 is configured to adjust the weights W₀ through W_{N} over time, based on use of the vehicle 10. For example, if the controller 24 notices that the driver routinely overrides the controller 24 in the same types of conditions, then the controller 24 can adjust the weights to accommodate for the preferences of the driver.

The controller 24 is configured to send instructions to the rear wiper 22 based on the weighted sum Y. In one example, the controller 24 compares the weighted sum Y to a number of thresholds. The controller 24 sends particular instructions to the rear wiper 22 depending on where the weighted sum Y falls relative to the thresholds. In one example, the value of weighted sum Y is always between 0 and 1. To this end, the factors X₀ through X_{N} may be a “0” or “1,” representing a “no” or “yes” respectively, and weights W₀ through W_{N} may be assigned such that Y cannot exceed 1. Alternatively, the value of the weighted sum Y is expressed as a percentage (i.e., between 0% and 100%).

In one example control scheme, there are three threshold values set and stored on the controller 24. The thresholds are expressed as values between 0 and 1 or as percentages, corresponding to the way Y is expressed. The threshold values include an upper threshold, a lower threshold, and an intermediate threshold between the upper and lower thresholds. There could be a different number of thresholds in other examples.

In one example, when the value of the weighted sum Y is greater than or equal to the upper threshold, there is a need for a relatively high level of wiping of the rear window 20. A lower level of wiping is needed when the value of the weighted sum Y is less than the upper threshold and greater than or equal to the intermediate threshold. An even lower level of wiping is needed when the value of the weighted sum is less than the intermediate threshold and greater than or equal to the lower threshold. When the value of the weighted sum Y is below the lower threshold, no wiping is needed.

An example relationship between the weighted sum Y and the instructions the controller 24 sends to the rear wiper 22 is expressed below in Table 1. In this example, the upper threshold is 80%, the intermediate threshold is 60%, and the lower threshold is 40%. It should be understood that other threshold values come within the scope of this disclosure. It should also be understood that the controller 24 could change the threshold values over time.

TABLE 1

| | Predefined | Predefined |
|---|---|---|
| Y | speed | time period |
| Greater than or equal to 80% | High | 1 minute |
| Less than 80% and greater | Medium | 1 minute |
| than or equal to 60% | | |
| Less than 60% and greater | Low | 15 seconds |
| than or equal to 40% | | |
| Less than 40% | Rear wiper off | n/a |

The predefined speeds in Table 1 are listed as “High,” “Medium,” and “Low.” It should be understood that these speeds are in relationship to one another. The actual rate of movement of the rear wiper 22 associated with these speeds may be set by a factory setting. Predefined time periods could be expressed in terms of cycles rather than an actual length of time. Either way, as noted above, the time periods are finite periods of time. As will be discussed below, the controller 24 is configured to reassess the value of the weighted sum Y after each time period, which allows the controller 24 to adjust the operation of the rear wiper 22 as wiping needs change.

In the example of Table 1, the controller 24 is configured to send instructions to the rear wiper 22 to run the rear wiper 22 at a high rate of speed for 1 minute if the weighted sum Y is above 80%. The weighted sum Y may be above 80% when the factors X₀ through X_{N} indicate that wiping is needed. For example, if the vehicle is in reverse, as represented by factor X₄, the driver is looking in the rear-view mirror, as represented by factor X₀, and there is a relatively high level of rain, as represented by factor X₁, then the weighted sum Y may be above 80%. Alternatively, even if there is no rain, the weighted sum Y may be above 80% if mud is splashed on the rear window 20. The presence of mud may be detected using the rear backup camera 28, as represented by factor X₅, and/or a vehicle-to-vehicle message, as represented by factor X₆. In particular, a front view camera of a vehicle behind the vehicle 10 may be able to detect that the rear window 20 is covered in mud. While a handful of examples have been discussed, it should be understood that any combination of the factors X₀ through X_{N} may result in any value for the weighted sum Y.

The controller 24 uses the weighted sum Y to instruct operation of the rear wiper 22 consistent with a control strategy, such as that expressed in Table 1. Again, it should be understood that Table 1 is only one example control strategy. Further, the predefined time periods could be substantially the same for different values of the weighted sum Y. For example, the predefined time periods could all be 1 minute. Alternatively, the predefined speeds could be the same for different values of the weighted sum Y. For example, the rear wiper 22 could run at a high speed for 1 minute when Y is above 80%, and could run at a high speed for 20 seconds when Y is above 60%. Accordingly, it should be understood that this disclosure extends to different combinations of thresholds, predefined speeds, and predefined time periods.

As discussed above, the controller 24 receives inputs and considers those inputs as factors when calculating the weighted sum Y. The controller 24 uses the weighted sum Y to estimate the level of wiping the rear window 20 needs. The vehicle 10 in this example does not include a rear window rain sensor. As such, this disclosure reduces cost by relying only on sensors that are already on the vehicle 10, without requiring a separate, dedicated rain sensor mounted adjacent the rear window. Further, while the controller 24 makes relatively accurate estimations, there may be circumstances where the estimation of the controller 24 is inconsistent with the preferences of the driver. In that case, the driver can override the controller 24 and manually control the rear window 20. As generally discussed above, when the user manually overrides the controller 24, the controller 24 may learn from that override, especially if the controller 24 is frequently overridden under similar conditions. The controller 24 may adjust the control scheme accordingly. Specifically, the controller 24 may adjust the weights W₀ through W_{N}, predefined times, predefined speeds, and/or thresholds, for example.

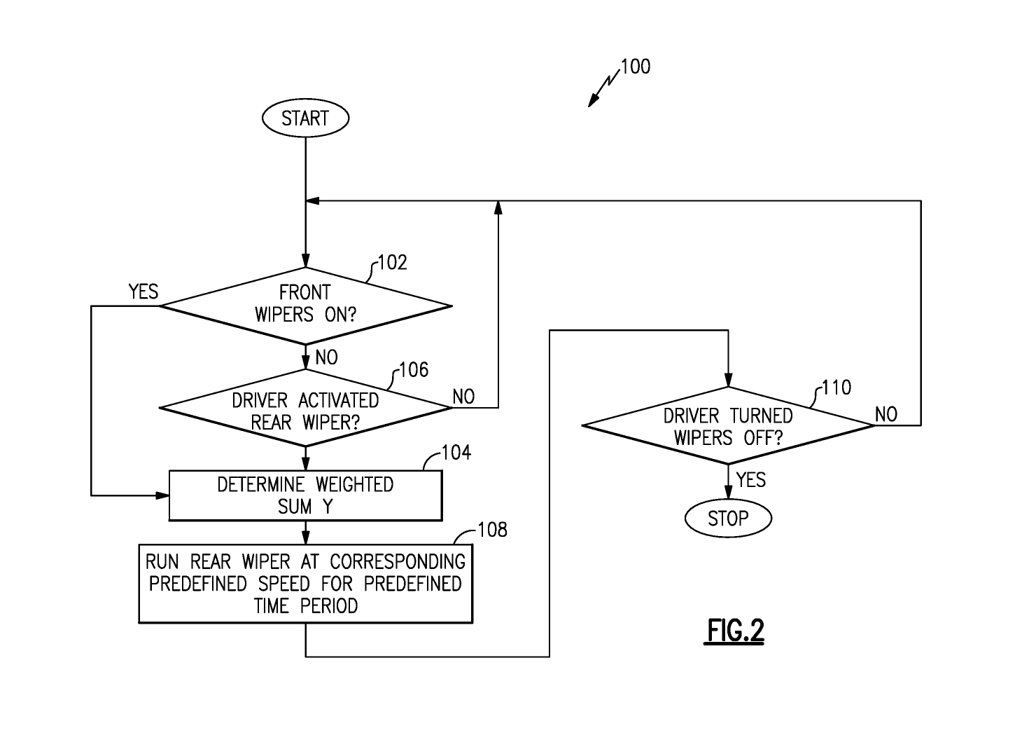

FIG. 2 is a flow chart representative of an example method 100 of use. In the method 100, the controller 24 selectively provides instructions to the rear wiper 22 to run the rear wiper 22 at certain speeds for certain times. It should be understood that the method 100 will be performed by the controller 24 and other components of the vehicle 10, such as those discussed above relative to FIG. 1.

At 102, the controller 24 determines whether the front wipers 14, 16 are turned on. The front wipers 14, 16 may be turned on manually by the driver or automatically in response to a reading from the front wiper rain sensor 30. Generally speaking, the front wipers 14, 16 are turned on because it is raining, and thus the rear wiper 22 should also be turned on. If the front wipers 14, 16 are turned on, the method 100 continues to determine the weighted sum Y, at 104. In this way, the method 100 provides for the automatic operation of the rear wiper 22 when the front wipers 14, 16 are turned on. Thus, the driver does not need to burden themselves with manually activating the rear wiper 22, which can be frustrating to some drivers that are not familiar with the rear wiper controls.

Alternatively, the method 100 can control the rear wiper 22 even if the front wipers 14, 16 are not turned on. If the front wipers 14, 16 are not turned on, the method 100 determines whether the driver has manually turned on the rear wiper 22, at 106. If not, the method 100 reverts back to the start. Otherwise, the method 100 continues to step 104.

At 104, the controller 24 considers each of the plurality of factors X₀ through X_{N}, as they are reported to the controller 24 from various the sources. The controller 24 determines the weighted sum Y using Equation 1, for example. At 108, the controller 24 instructs the rear wiper 22 to run at a predefined speed for a predefined time period based on the weighted sum Y. One example control scheme is discussed above and expressed in Table 1. After the predefined time period lapses, the controller 24 determines whether the driver has turned off the front wipers 14, 16, at 110. If so, the method stops. If not, the method reverts back to the start, where a new weighted sum Y is calculated and the rear wiper is instructed accordingly. At 110, the method may also stop if the driver has manually turned off the rear wiper 22. Alternatively, the method 100 may stop during any step if the user manually turns off the rear wiper 22.

While the above-discussion is centered around control of the rear wiper 22, one would understand that certain aspects of this disclosure could be used to determine when, and to what extent, to apply washer fluid to the rear window 20. The application of washer fluid to the rear wiper 22 during the method 100 is contemplated by this disclosure.

It should be understood that terms such as “about,” “substantially,” and “generally” are not intended to be boundaryless terms, and should be interpreted consistent with the way one skilled in the art would interpret those terms. It should also be understood that terms such as “forward,” “rear,” etc., are used herein relative to the normal operational attitude of the vehicle 10 for purposes of explanation only, and should not be deemed limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A system for a motor vehicle, comprising:
a controller; and
a rear wiper configured to wipe a rear window of the motor vehicle in response to instructions from the controller, wherein the controller is configured to instruct the rear wiper to run at a predefined speed for a predefined time period based on a plurality of factors.

2. The system as recited in claim 1, wherein:
a weight is assigned to each of the plurality of factors, and
the controller is configured to instruct the rear wiper to run at the predefined speed for the predefined time period based on a weighted sum of the factors.

3. The system as recited in claim 2, wherein the weights are factory settings of the motor vehicle.

4. The system as recited in claim 3, wherein the controller is configured to change the weights over time.

5. The system as recited in claim 2, wherein the controller is configured to instruct the rear wiper to run at a first speed for a first time period when the weighted sum is greater than or equal to an upper threshold.

6. The system as recited in claim 5, wherein:
the controller is configured to instruct the rear wiper to run at a second speed for a second time period when the weighted sum is less than the upper threshold and greater than or equal to an intermediate threshold, and
the second speed is less than the first speed.

7. The system as recited in claim 6, wherein:
the controller is configured to instruct the rear wiper to run at a third speed for a third time period when the weighted sum is less than the intermediate threshold and greater than or equal to a lower threshold, and
the third speed is less than the second speed.

8. The system as recited in claim 7, wherein:
the controller is configured to stop the rear wiper when the weighted sum is less than the lower threshold.

9. The system as recited in claim 1, wherein the plurality of factors includes at least two of a user input, a signal from a rain sensor, a speed of the motor vehicle, a signal from a front camera, a gear position, a signal from a rear camera, a vehicle-to-vehicle message, and a shape of an exterior of a body of the motor vehicle.

10. The system as recited in claim 9, wherein the user input includes a signal indicative of an eye position of the user.

11. The system as recited in claim 1, wherein the controller is configured to instruct the rear wiper to run at a speed other than the predefined speed based on a user override.

12. The system as recited in claim 1, wherein the motor vehicle does not include a rear window rain sensor.

13. A method, comprising:
wiping a rear window by running a rear wiper at a predefined speed for a predefined time period based on a plurality of factors.

14. The method as recited in claim 13, further comprising:
assigning weights to the plurality of factors; and
running the rear wiper based on a weighted sum of the plurality of factors.

15. The method as recited in claim 14, further comprising:
changing the weights over time.

16. The method as recited in claim 13, further comprising:
running the rear wiper at a first speed when a weighted sum of the plurality of factors is greater than or equal to an upper threshold; and
running the rear wiper at a second speed when the weighted sum is less than the upper threshold and greater than or equal to a first intermediate threshold, the second speed less than the first speed.

17. The method as recited in claim 16, further comprising:
running the rear wiper to at a third speed when the weighted sum is less than the first intermediate threshold and greater than or equal to a lower threshold, the third speed less than the second speed.

18. The method as recited in claim 17, further comprising:
stopping the rear wiper when the weighted sum is less than the lower threshold.

19. The method as recited in claim 13, wherein the plurality of factors does not include a signal from a rear window rain sensor.

20. The method as recited in claim 13, further comprising:
wiping the rear window by running a rear wiper at a speed other than the predefined speed based on a user override.
